(19) United States
(12) Patent Application Publication
(10) Pub. No.: US 2022/0140433 A1
(43) Pub. Date: May 5, 2022

(54) High-Voltage Accumulator for Vehicles

(71) Applicant: Bayerische Motoren Werke Aktiengesellschaft, Muenchen (DE)

(72) Inventors: Philip RAETTICH, Bidingen (DE); Frank TENFELDE, Muenchen (DE)

(21) Appl. No.: 17/258,819

(22) PCT Filed: Jun. 12, 2019
(86) PCT No.: PCT/EP2019/065311

§ 371 Date: Jan. 8, 2021

(30) Foreign Application Priority Data
Jul. 9, 2018 (DE) 10 2018 211 317.3

(51) Int. Cl. H01M 50/367; H01M 10/625; H01M 10/613; H01M 10/6569

(52) U.S. Cl. CPC H01M 50/367; H01M 10/625; H01M 50/383; H01M 10/6569; H01M 2220/20; H01M 10/613

(57) ABSTRACT

A high-voltage accumulator for vehicles, includes a high-voltage accumulator housing, and at least one accumulator cell which is arranged in the high-voltage accumulator housing and has an emergency degassing opening that opens when a specified accumulator cell internal pressure is exceeded and allows hot gas to exit the interior of the accumulator cell into the interior of the high-voltage accumulator housing. A chamber filled with a phase-changing medium is provided in the region of the emergency degassing opening of the at least one accumulator cell. The chamber is directly or indirectly supplied with hot gas when the hot gas exits the interior of the accumulator cell, whereby heat is input into the phase-changing medium and the phase-changing medium is heated and/or transitions into a high-energy aggregate state.

### BACKGROUND AND SUMMARY OF THE INVENTION

The present invention relates to a high-voltage accumulator for vehicles.

Hybrid or electric vehicles are equipped with a high-voltage accumulator, in which electrical energy for driving a vehicle propulsion-generating electrical machine is stored. A high-voltage accumulator of this type customarily comprises a high-voltage accumulator housing having a plurality of electrical storage cells arranged therein. A plurality of such storage cells are customarily electrically interconnected to form a “cell module”. A plurality of such cell modules are customarily located in the high-voltage accumulator housing.

In the event of severe accidents, the high-voltage accumulator or individual storage cells can sustain damage which, under unfavorable circumstances, can result in internal short-circuiting of cells and, as a result, in an increase in pressure and/or temperature in the interior of individual storage cells and, in extreme cases, in the escape of hot or burning gases from storage cells. Accordingly, storage cells of high-voltage accumulators customarily incorporate an “emergency degassing opening” which, in the event of an overshoot of a predefined internal cell pressure, opens and permits a controlled escape of gas from the interior of the cell.

If individual storage cells or a plurality of storage cells undergo excessive heat-up and hot or burning gases escape, any “propagation” of hot or burning gases, or damage to “adjoining” storage cells by hot or burning gases, should be prevented insofar as possible.

One option for the reduction of the risk of any such “propagation” involves the employment of cell materials which are as heat-resistant as possible and/or the incorporation of “mechanical” barriers in the high-voltage accumulator, which prevent any dissemination of hot gases or flames, or at least delay such dissemination to the side. Solid materials such as, e.g. steel, glass-fiber fabric, rockwool matting, SMC, etc., are considered for this purpose. Materials of this type can only take up or discharge comparatively limited quantities of heat from the high-voltage accumulator, as their main function is the insulation or protection of individual storage cells. Customarily, there is thus a conflict of objectives between an effective insulating action in normal operation and a rapid dissipation of heat in the “event of propagation”. In the “event of propagation”, a major proportion of the heat energy escaping from individual storage cells remains in the interior of the high-voltage accumulator housing and, in extreme cases, can result in a chain reaction, i.e. a sequential failure of a plurality of or all the storage cells. A further problem exists in that it is technically extremely difficult or complex to detect the escape of hot or burning gases from storage cells in a prompt and reliable manner, and to alert the driver or passengers of the vehicle.

The object of the invention is the provision of a high-voltage accumulator for vehicles which has improved safety in the event of the escape of hot or burning gases from individual storage cells.

The starting point of the invention is a high-voltage accumulator for vehicles, having a high-voltage accumulator housing and at least one storage cell, which is arranged in the high-voltage accumulator housing. Naturally, a plurality of such storage cells can be arranged in the high-voltage accumulator housing. Groups of storage cells can also be electrically interconnected to form cell modules. A plurality of such cell modules in combination can form the high-voltage accumulator battery.

The at least one storage cell has an emergency degassing opening. In normal operation of the storage cell, i.e. when the storage cell is in a correct (operating) state, the emergency degassing opening which is provided in or on the housing of the storage cell is closed in a gas-tight manner. In the event of an overshoot of a predefined internal storage cell pressure, e.g. as a result of mechanical damage to the storage cell or as a result of an internal short-circuit in the cell, the emergency degassing opening opens or fails, thus permitting a relief of pressure in the interior of the storage cell housing, i.e. an escape of hot or burning gas from the interior of the storage cell or the storage cell housing into an interior space of the high-voltage accumulator.

The core element of the invention is the provision, in the region of the emergency degassing opening of the at least one storage cell, of a chamber filled with a “phase-changing medium” (e.g. water) which chamber, in the event of an escape of hot gas, is acted on indirectly or directly by the hot gas, as a result of which heat is input from the hot gas into the phase-changing medium, and the latter undergoes heat-up and/or transitions to a high-energy aggregate state (e.g. steam).

The phase-changing medium can be e.g. water or a substance consisting predominantly of water. The phase-changing medium is preferably a substance which, at least down to a given temperature of, e.g., −20° C., −25° C., −30° C., −35° C., −40° C., is in a fluid state. This substance is, for example, water which contains a sufficient proportion of antifreezing agent (e.g. an alcohol such as, for example, glycol).

The fundamental concept of the invention is thus that of taking up a major proportion of the thermal energy which escapes from the at least one storage cell in the case of the venting of hot or burning gas in the phase-changing medium, in order thereby to prevent or to at least or temporally delay any propagation, i.e. transfer to other storage cells.

According to a further development of the invention, the chamber which is filled with the phase-changing medium is provided on an inner side of a wall of the high-voltage accumulator housing which faces the interior space of the high-voltage accumulator. Alternatively or additionally, the chamber can also be arranged on an outer side of the wall of the high-voltage accumulator which is averted from the interior space of the high-voltage accumulator. Alternatively or additionally, the chamber can also be integrated in the wall of the high-voltage accumulator. Alternatively or additionally, the chamber can also be provided on another component of the high-voltage accumulator or can be integrated in another component of the high-voltage accumulator. The other component can be, for example, a cell contact-connection system, by means of which poles of individual storage cells which are interconnected to form a cell module are electrically connected to one another.

The term “wall” is to be understood in the broadest sense here. The wall can be, for example, a lower wall, in relation to the direction of gravitational force (high-voltage accumulator housing base), or an upper wall (high-voltage accumulator housing cover) or a side wall of the high-voltage accumulator housing.

The emergency degassing opening of the at least one storage cell, in relation to the direction of gravitational force, preferably faces an upper wall (high-voltage accumulator housing cover), and the chamber in which the phase-changing medium is located is preferably provided on or in the upper wall.

According to a further development of the invention, the thermal energy which is released in the case of the discharge of hot or burning gases is not only absorbed by the phase-changing medium, but is also discharged via the phase-changing medium into the environment. To this end, a pressure-relief valve can be provided in or on the chamber or in a discharge channel which is connected to the chamber, which pressure-relief valve, in its initial state, i.e. when the high-voltage accumulator and the storage cells arranged therein are in a correct state, is closed and which pressure-relief valve opens if the phase-changing medium exceeds a predefined pressure, or the internal pressure in the chamber exceeds a predefined pressure. For example it can be provided that, if the phase-changing medium begins to boil, the pressure-relief valve opens, and phase-changing medium can be discharged via the pressure-relief valve into the environment. In this manner, large quantities of thermal energy can be discharged from the high-voltage accumulator.

For example, it can be provided that the pressure-relief valve is closed up to a predefined pressure.

The chamber in which the phase-changing medium is located can be directly connected to the at least one storage cell or to a cell module or to a wall of the high-voltage accumulator housing (e.g. to the housing cover), or can be part of these components. The chamber forms a closed system which, in the normal operating state, is filled with the phase-changing medium. The phase-changing medium should have the maximum possible enthalpy of vaporization (as applies e.g. in the case of water), and should ideally have a vaporization temperature (also under pressure) which is lower than the melting point of the chamber and/or the melting point of the storage cell housing or of the cell module.

According to a further development of the invention, an acoustic signal generator is provided in the pressure-relief valve or on the pressure-relief valve or in a channel between the pressure-relief valve and a discharge opening of the channel into the environment, which signal generator, upon the outflux of phase-changing medium, which may be in a liquid or gaseous state or a partially liquid and gaseous state, generates an acoustic hazard signal. The hazard signal should be sufficiently loud that it is also reliably heard in the passenger compartment of a vehicle in which the high-voltage accumulator is installed. A hazard signal of this type, which is generated in an entirely mechanical manner by the simple outflux of phase-changing medium, is thus highly reliable, and can be generated with limited costs. The principle of a “kettle whistle” is thus employed.

According to a further development of the invention, a pressure equalization device is provided in one wall of the high-voltage accumulator housing, via which pressure equalization device (hot or burning) gas which is propagated from one or more storage cells into the interior space of the high-voltage accumulator housing can be discharged into the environment and/or via which pressure equalization device ambient air can flow into the interior space of the high-voltage accumulator housing. It is thus ensured that at least approximately the same pressure prevails in the interior space of the high-voltage accumulator as in the environment.

The pressure equalization device preferably comprises a semi-permeable membrane, through which water vapor can be discharged from the interior of the high-voltage accumulator housing into the environment, but which prevents any ingress of water from the environment into the interior space of the high-voltage accumulator housing.

In the interests of completeness, it should be mentioned that the subject matter of the invention is not limited to the above-described high-voltage accumulator, but also includes a vehicle having a high-voltage accumulator of this type.

The invention is described in greater detail hereinafter in conjunction with the drawing.

### BRIEF DESCRIPTION OF THE DRAWING

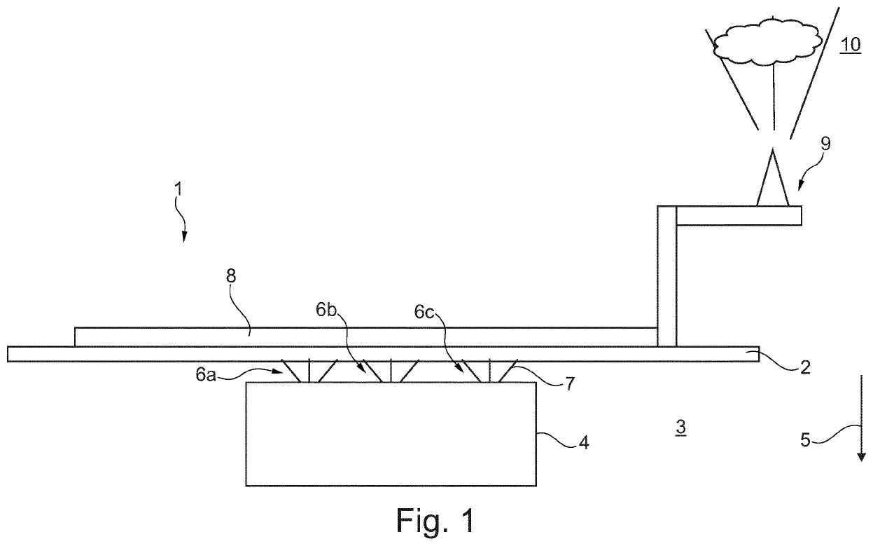

The single FIG. 1 illustrates the basic principle of the invention in a highly schematic representation.

### DETAILED DESCRIPTION OF THE DRAWING

FIG. 1 shows a high-voltage accumulator 1 of a vehicle (not represented in greater detail here). The high-voltage accumulator 1 comprises a high-voltage accumulator housing, of which only a high-voltage accumulator housing cover 2 is represented here. In an interior space 3 of the high-voltage accumulator housing, there are arranged a plurality of cell modules 4, each of which is formed by a plurality of storage cells (not represented in greater detail) which are configured in a “nested” arrangement one behind another. Each of the storage cells has, in its upper region, in relation to the direction of gravitational force 5, an emergency degassing opening 6a, 6b, 6c. When the storage cells are in a correct state, the emergency degassing openings are closed in a gas-tight manner. In the event of an overshoot of a predefined internal pressure in the storage cells, the emergency degassing openings 6a-6c open or fail, and permit an outflux of hot or burning gas 7 into the interior space 3 of the high-voltage accumulator housing.

As can be seen from FIG. 1, the hot or burning gas 7 is applied to the high-voltage accumulator housing cover and thus also to a chamber 8 which is provided on the high-voltage accumulator housing cover 2 and which is filled with a phase-changing medium (e.g. water with an added antifreezing agent). In the normal state of the high-voltage accumulator 1, the chamber 8, which can also be referred to as a “channel”, is closed. However, the chamber 8 has a pressure-relief valve 9, which can be configured in the manner of a whistle. In the event of an outflux of hot or burning gas from one or more storage cells, the phase-changing medium which is located in the chamber 8 undergoes heat-up, thereby resulting in a rise in pressure and even potentially in the boiling of the phase-changing medium which is located in the chamber 8. In the event of an overshoot of a predefined pressure in the interior of the chamber 8, the pressure-relief valve opens, thus permitting a release of hot or boiling phase-changing medium into the environment 10. As a result, relatively large quantities of thermal energy can be dissipated from the interior 3 of the high-voltage accumulator 1, thereby reducing the risk of any propagation of hot or burning gas, i.e. any damage to adjoining storage cells.

1.-11. (canceled)

12. A high-voltage accumulator for a vehicle, comprising:
a high-voltage accumulator housing;
at least one storage cell, which is arranged in the high-voltage accumulator housing and which has an emergency degassing opening which, in an event of an overshoot of a predefined internal storage cell pressure, opens and permits a venting of hot gas from an interior of the storage cell into an interior space of the high-voltage accumulator housing,
wherein, in a region of the emergency degassing opening of the at least one storage cell, a chamber filled with a phase-changing medium is provided, which chamber, in an event of an escape of hot gas, is acted on indirectly or directly by the hot gas, whereby heat is input into the phase-changing medium, and the phase-changing medium undergoes heat-up and/or transitions to a high-energy aggregate state.

13. The high-voltage accumulator according to claim 12, wherein one of:
(i) the chamber is arranged on an inner side of a wall of the high-voltage accumulator which faces the interior space of the high-voltage accumulator housing,
(ii) the chamber is arranged on an outer side of the wall of the high-voltage accumulator which is averted from the interior space of the high-voltage accumulator housing, or
(iii) the chamber is integrated in the wall of the high-voltage accumulator housing.

14. The high-voltage accumulator according to claim 12, wherein
the high-voltage accumulator housing comprises an upper wall, in relation to the direction of gravitational force,
the emergency degassing opening of the at least one storage cell faces the upper wall, and
the chamber is provided on or in the upper wall.

15. The high-voltage accumulator according to claim 12, wherein
the chamber has a pressure-relief valve which opens when the phase-changing medium exceeds a predefined pressure, wherein phase-changing medium is discharged in the case of the opened pressure-relief valve out of the chamber into the environment.

16. The high-voltage accumulator according to claim 15, wherein
the chamber and the pressure-relief valve are closed up to a predefined pressure.

17. The high-voltage accumulator according to claim 15, wherein
an acoustic signal generator is provided in the pressure-relief valve, on the pressure-relief valve, or in a channel between the pressure-relief valve and a discharge opening of the channel into the environment, and
the signal generator generates an acoustic hazard signal by way of the outflux of phase-changing medium into the environment.

18. The high-voltage accumulator according to claim 12, wherein
the phase-changing medium is at least predominantly composed of water.

19. The high-voltage accumulator according to claim 12, wherein
the phase-changing medium contains an antifreezing substance, whereby the phase-changing medium is ensured to be in a fluid state at least down to a temperature of −20° C.

20. The high-voltage accumulator according to claim 12, wherein
a pressure equalization device is provided in one wall of the high-voltage accumulator housing, via which pressure equalization device gas which is located in the interior space of the high-voltage accumulator housing is discharged into the environment and/or via which pressure equalization device ambient air flows into the interior space of the high-voltage accumulator housing.

21. The high-voltage accumulator according to claim 20, wherein
the pressure equalization device comprises a semi-permeable membrane through which water vapor is discharged from the interior space into the environment, but which prevents any ingress of water from the environment into the interior space.

22. A vehicle comprising a high-voltage accumulator according to claim 12.
